(19) United States
(12) Patent Application Publication
(10) Pub. No.: US 2009/0100496 A1
(43) Pub. Date: Apr. 16, 2009

(54) MEDIA SERVER SYSTEM

(76) Inventors: Andreas Bechtolsheim, Incline Village, NV (US); David R. Cheriton, Palo Alto, CA (US)

Correspondence Address: MHKKG/SUN, P.O. BOX 398, AUSTIN, TX, 78767, US

(21) Appl. No.: 12/297,398

(22) PCT Filed: Apr. 24, 2007
(86) PCT No.: PCT/US07/67318

§ 371 Date: Oct. 16, 2008

Related U.S. Application Data
(60) Provisional application No. 60/794,419, filed on Apr. 24, 2006.

(51) Int. Cl. H04N 7/16; H04L 12/50

(52) U.S. Cl. 725/147; 370/360

(57) ABSTRACT

A media server system includes a switch having a volatile memory such as dynamic random access memory (DRAM), for example. The switch may be configured to store one or more formatted media content streams in large blocks within the volatile memory. The switch unit also includes a switch controller including a crossbar switch that is coupled between a plurality of network ports and the volatile memory. The switch controller may be configured to create one or more concurrent media streams from one of the one or more formatted media content streams by concurrently performing read operations to a plurality of portions of the volatile memory, and to concurrently route the one or more concurrent media streams via any of the plurality of network ports, which may provide a digital transport for conveying the one or more concurrent media streams for use by the subscriber

### BACKGROUND OF THE INVENTION

1. Field of the Invention

This invention relates to digital cable media providers and, more particularly, to the interactive television and multimedia service equipment.

2. Description of the Related Art

Since the introduction of digital cable television services, the demand for interactive television (iTV) services has been on the rise. Market research predicts that 33% of digital subscribers will use next-generation iTV services including network personal video recording (nPVR), on-demand television, and video on demand (VOD). For a centralized cable head end serving a metropolitan area of 500 K homes passed, and assuming 35% of homes passed are digital subscribers with 1.5 televisions per household, the number of simultaneous virtual private streams may be 87,500 streams. Over time, higher adoption of iTV services is expected.

These services are of great interest to cable operators because they can provide significant incremental revenue streams. The combination of nPVR, on-demand television, VOD, and individual advertising is projected to increase the revenue per subscriber by $10 to $20 per month ($120 to $240 per year). In addition, iTV may reduce subscriber turn over by offering an individualized entertainment experience that, in many cases, cannot be matched by satellite. Thus iTV may be a critical aspect to the future of the cable industry.

One key industry challenge is how to deliver iTV in a scalable, cost-effective and highly reliable fashion that enables high penetration rates and continuous subscriber usage. Scalability is critical because if interactive services cannot be delivered to all iTV subscribers, the credibility of the entire service offering may be compromised. The promise of many on demand video services is to “get what you want when you want it.” Lack of scalability undermines that message to the consumer. The number of streams required depends on a number factors including iTV penetration, the number of televisions per household, and maximum simultaneous use assumptions.

The economics of interactive services are very sensitive to scalability and cost per stream. Initial VOD trials that deliver movies-on-demand could amortize the cost for each stream over many subscribers, because each subscriber uses the VOD service only occasionally. In contrast, nPVR service requires dedicated stream capacity for each subscriber such that all subscribers can take advantage of the nPVR service even during peak demands. This type of service requires a radically lower cost structure than traditional VOD servers because the capital cost per stream can only be amortized over the revenue from a single subscriber.

Finally, subscribers and operators expect a highly reliable service. Customer satisfaction drops dramatically with downtime. Because iTV requires significantly more components than a conventional broadcast cable network, it is important that the iTV architecture supports cost-effective redundancy and failover mechanisms.

### SUMMARY

Various embodiments of a media switch and media server system are disclosed. In one embodiment, a switch includes a volatile memory such as dynamic random access memory (DRAM), for example. The switch may be configured to store one or more formatted media content streams in large blocks within the volatile memory. The switch unit also includes a switch controller including a crossbar switch that is coupled between a plurality of network ports and the volatile memory. The switch controller may be configured to create one or more concurrent media streams from one of the one or more formatted media content streams by concurrently performing read operations to a plurality of portions of the volatile memory, and to concurrently route the one or more concurrent media streams via any of the plurality of network ports, which may provide a digital transport for conveying the one or more concurrent media streams for use by the subscriber.

In another embodiment, a media streaming system includes a stream manager including a preprocessor configured to format an incoming media content stream. The system also includes a media storage such as a hard disk array, for example, that may be configured to store formatted blocks of the media content stream. The system further includes a switch unit including a volatile memory configured to temporarily store one or more formatted media content streams. The switch unit also includes a switch controller including a crossbar switch coupled between a plurality of network ports and the volatile memory. The switch controller may be configured to create one or more media streams from one of the one or more formatted media content streams by concurrently performing read operations to a plurality of portions of the volatile memory, and to concurrently route the one or more concurrent media streams via any of the plurality of network ports.

### BRIEF DESCRIPTION OF THE DRAWINGS

FIG. 1 is a block diagram of one embodiment of a cable television system.

FIG. 2 is a block diagram of one embodiment of the stream system of FIG. 1.

FIG. 3 is a block diagram of one embodiment of a stream system including redundant components.

FIG. 4 is a flow diagram that describes aspects of the operation of the embodiments shown in FIG. 1 and FIG. 2.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims. It is noted that the word “may” is used throughout this application in a permissive sense (i.e., having the potential to, being able to), not a mandatory sense (i.e., must).

### DETAILED DESCRIPTION

While each cable system is unique in its topology and configuration, the canonical HFC architecture (SCTE DVS 073, for example) consists of a centralized head end that feeds content to one or more distribution hubs and distribution nodes using fiber optic cable. At a distribution node the optical signals are converted to electrical signals and distributed over coaxial cable to a set-top box (STB) in a given location.

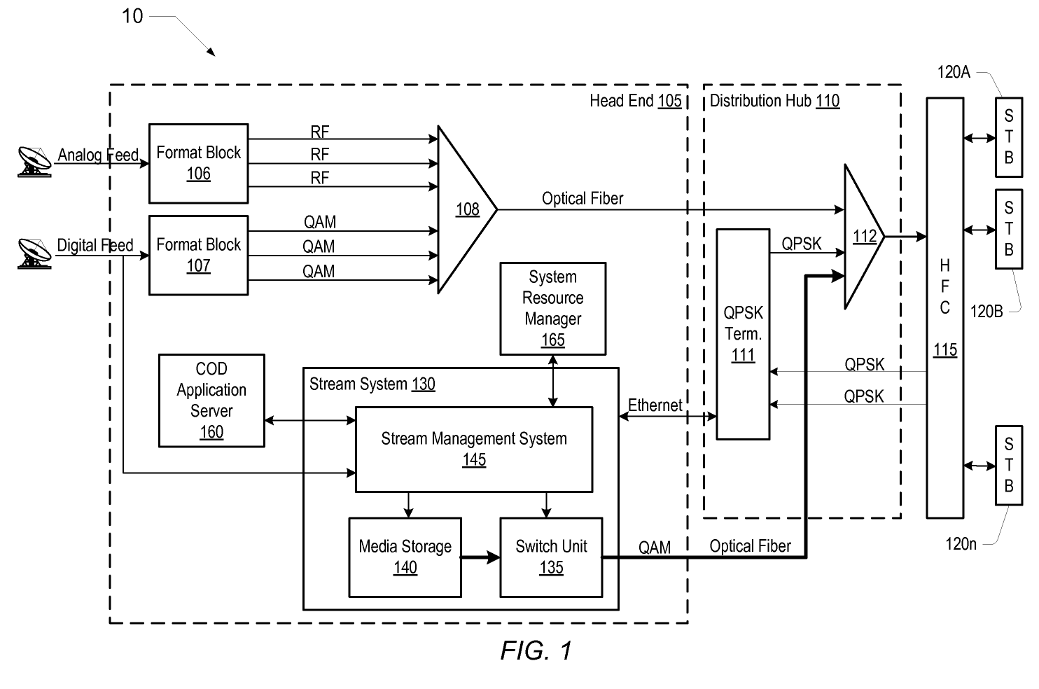

Turning now to FIG. 1, a block diagram of one embodiment of a cable television system 10 is shown. The system 10 includes a head end 105 that is coupled to a distribution hub 110. The distribution hub 110 is coupled to hybrid fiber coax (HFC) unit 115, which is coupled to any number of set top boxes, designated STB 120A through 120n (where n may be any number constrained only by the specific system implementation). It is noted that components that include a number and a letter may be referred to by the number only where appropriate such as, for example, STB 120 may be used when referring generally to any STB. It is further noted that in some embodiments, there may be additional components that are not shown for simplicity.

In the illustrated embodiment, the head end 105 may be configured to receive analog and digital broadcast programs (e.g., via satellite, landline, etc.) and to convert them for delivery over the cable network. Thus, head end 105 includes formatting blocks 106 and 107 which may convert the digital broadcast content into quadrature amplitude modulated radio frequency signals (e.g., QAM-64 or QAM-256 signals). The QAM signals may be converted to optical signals via conversion unit 108 and provided to one or more distribution hubs 110. The head end 105 is typically a staffed facility provided with heating, ventilation, and air conditioning equipment.

The QPSK termination unit 111 within distribution hub 110 may be configured to terminate the radio frequency portion of the QPSK-modulated out-of-band signaling channel both the forward and reverse directions. In addition, a conversion unit 112 in the distribution hub 110 may convert optical signals to electrical signals for distribution to HFC 115.

A digital STB 120 is a special-purpose graphics and communications computer that may be located at a subscriber's home or office. In some embodiments, STB 120 may be representative of a lower cost STB like the Motorola DCT2000™ and the Scientific Atlanta Explorer 2000™. As such the STB 120 may include one or more processors that may execute application software. A low cost digital STB typically exhibits a number of characteristics such as one tuner can receive a 6 to 8 MHz TV channel (6 MHz corresponds to an NTSC channel, and 8 MHz corresponds to a PAL channel). The 6-8 MHz channel can contain either an analog television channel, or a digital MPEG-2 transport stream (that can itself contain several separate video and audio streams). Each digital channel (typically referred to as a Forward Application Transport (FAT) channel) is QAM-64 or QAM-256 modulated and carries 27 or 38.8 Mbps respectively. In addition, the STB 120 may include a video display system that can perform various graphics processing functions, a remote control device that enables a user to interact with the graphical user interface presented by an STB application. The STB 120 may also provide an out-of-band bidirectional communications system that can exchange IP packets with application servers in the cable head end over the forward and reverse data channels. As mentioned above, the out-of-band system uses QPSK modulation in both forward and reverse directions as shown. Furthermore, the STB 120 may provide a conditional access system (not shown) that may include a secure element for descrambling the input channel (analog or digital).

The STB 120 is connected to the coaxial section of the HFC 115 network. The RF spectrum on the coaxial cable is divided into three regions: five 40 MHz reverse data channels, 50 550 MHz analog TV channels, and 550 840 MHz digital TV channels (FAT channels). Each FAT channel includes one MPEG-2 Transport Stream (TS) multiplex. The MPEG-2 TS multiplex can contain several video and audio programs. Typically, a television program uses a 3.75 Mbps constant bit rate MPEG2 stream, which means that 10 television channels can fit into one FAT channel. One of the FAT channels is typically dedicated to supporting a broadcast data carousel function that allows the set-top box to mount a remote file system. This is used, for example, to download application software or program guide information to the set-top boxes. Because there is only one QAM receiver, the set-top box can generally only receive data from one QAM channel at a time. For example, while the STB 120 is busy receiving data from the data carousel channel, it cannot receive video. However, within the STB 120, the QPSK transmitter and receiver for the out of band channel can operate at the same time as the QAM receiver. Thus, while receiving a QAM channel, the STB 120 can send and receive IP data on the forward and reverse data channels.

Accordingly, a subscriber may request on-demand programming via the STB 120. Additionally, as will be described in greater detail below, a plurality of subscribers may independently request and asynchronously receive the same on-demand programming.

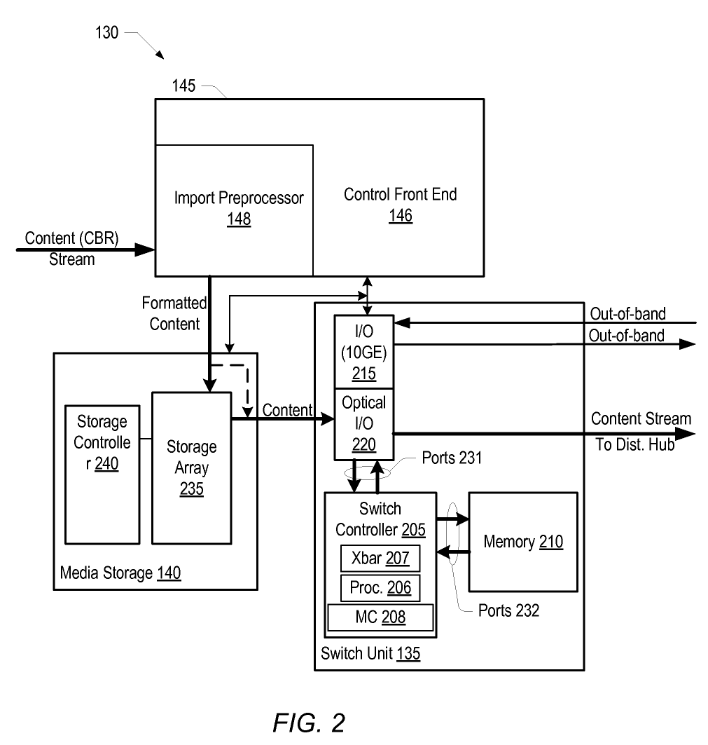

To facilitate this type of on-demand programming, the head end 105 stores content and manages multiple concurrent streams that may be viewed by subscribers in a true on-demand fashion. Accordingly, head end 105 includes a stream system 130 that includes a stream management system 145, a media storage 140, and a switch unit 135. Stream system 130 may be configured to receive and format media content such as video, for example, for subsequent on-demand viewing. As will be described further below, in one embodiment in response to a number of subscribers requesting to receive a number of respective media streams, the stream management system 145 may coordinate the transfer of large blocks of formatted media data from the media storage 140 to the switch unit 135 where the formatted media data is stored in a volatile cache memory associated with switch unit 135 (shown in FIG. 2). The cached media data may be streamed out of switch unit 135 using a number of independently controlled streams to the respective independent subscribers. In one particular implementation, the switch unit 135 may be configured to provide over 80,000 virtual private media streams such as motion picture experts group (MPEG-2) streams from a single server without content replication. It is contemplated that other types of streams in addition to MPEG-2 may also be provided.

In the illustrated embodiment, head end 105 also includes a content on demand (COD) application server 160, and a system resource manager (SRM) 165 that are coupled to the stream management system 145. These units may coordinate end-to-end resources for delivering a stream to a subscriber. In addition a COD application running on the STB 120 and the COD application server 160 may communicate via proprietary and application-specific protocols. The SRM 165 may be implemented as a variety of separate systems such as a billing system and a network management system, for example.

Referring to FIG. 2, a block diagram of one embodiment of the stream system of FIG. 1 is shown. The stream system 130 includes a stream management system 145 that is coupled to a media storage 140, which is in turn coupled to a switch unit 135. It is noted that components that correspond to those shown in FIG. 1 are numbered identically for clarity and simplicity.

In one embodiment, the stream management system 145 may be implemented as a blade server system. Thus, it may provide a high density of network interconnected CPU server blades and software that interfaces to other head-end services, including subscriber databases, digital asset management systems, and system resource management systems such as SRM 165 of FIG. 1. More particularly, the CPU server blades may be configured through software to implement any of a variety functions. As shown in FIG. 2, the stream management system 145 includes a control front end 146 and an import preprocessor 148. As described further below, the stream system 130 may be configured to operate as a distributed computing platform. As such, the blade server system may include a number of redundant and/or duplicated servers that share functionality thereby providing not only distributed computing functionality but also failover functionality.

In one embodiment, the control front end 146 may be configured to match a subscriber choice to available titles, determine the availability of network resources to deliver the content, and to communicate with the switch unit 135 and media storage 140 to deliver the requested stream. In addition, the control front end 146 may be configured to receive from the STB 120 subscriber trick play requests such as, for example, pausing, resuming, rewinding, and fast-forwarding a stream. The control front end 146 may communicate with the switch unit 135 and media storage 140 to cause these trick play requests to be performed on the stream. The control front end 146 may also be configured to locate and cause to be inserted advertising suitable for a particular subscriber based on subscriber profile, operator policy and even subscriber immediate behavior. Further, the control front end 146 may be configured to support coupling of subscriber actions to a separate T-commerce service that may support on-line purchases, etc. For example, to satisfy one Video-on-Demand request, the control front end 146 may play previews, advertisements, and the movie in several separate segments over one stream by mapping from the subscriber service aspect of requesting a particular movie, to the media storage notion of individual SegStreams (described further below).

The control front end 146 may be configured to distribute active subscriber sessions across the multiple server blades of the stream management system 145 to provide scalable performance with high availability and good subscriber response. The control front end 146 may also be configured to provide configuration management and to manage failure recovery for the stream system 130 including the switch unit 135 and media storage 140 components.

The control front end 146 interfaces to the rest of the head-end infrastructure such as subscriber database, billing and asset management. The control front end 146 interface describes the primary objects provided by this library. More particularly, the control front end 146 is configured to handle interaction with the subscriber, providing a unit of failure/recovery that is specific to a subset of the subscribers and segregated from the media storage 140 and switch unit 135 software modules. The control front end 146 also encapsulates that portion of software that needs to interface to the external head-end infrastructure.

In one embodiment, the import preprocessor 148 that may be configured to receive incoming MPEG-2 content streams, both prerecorded and live, and to process the streams into a form suitable for storage and transmission including trick play features. Streams may be preprocessed incrementally for real-time operation, or batched for more efficient operation. In one embodiment, the input MPEG-2 content stream may be received in a constant bit rate (CBR) format. The import preprocessor 148 may be configured to extract information such as timing information, for example, from the input CBR stream and then break the stream into large Ethernet frames referred to as “jumbograms” for efficient transmission via the switch unit 135. In one implementation, the import preprocessor 148 may format the content into 8 kilobyte user datagram protocol/Internet protocol (UDP/IP) Ethernet frames aggregated into 1 Mbyte blocks. In addition, the import pre-processor 148 may encapsulate IP packets into MPEG-2 TS, using multi-protocol encapsulation (MPE) such as digital storage media command and control (DSM-CC), for example.

Data transmitted through the stream system 130 may be considered to be content. Content is divided into offline content, which may be acquired, processed, and stored ahead of time, and live content, which may be acquired, processed, and transmitted on the fly. Most live content may be stored, but some live content may be transmitted to the rest of the system without requiring storage (for example, the stream system operator may not have legal rights to store a particular piece of content). Accordingly, the import pre-processor 148 may further instruct the media storage 140 to either store the content or to simply bypass or stream it through to switch unit 135 (as indicated by the dashed arrow).

As described above, the switch unit 135 requires stream data to be accumulated into “jumbogram”-sized chunks. In one implementation, a jumbogram is 8 kilobytes of data, prepacketized into IP packets. Further, trick play modes such as fast-forward require separate segments. The import pre-processor 148 takes input MPEG-2 transport streams or program streams and produces the on-disk format of video streams, as well as metadata necessary for content loading and trick play modes. The import preprocessor 148 may insert padding as required to ensure constant bit rate streams.

More particularly, video is managed in collections referred to a “titles” that correspond to a particular movie or TV show. Each title is broken up into a number of logically grouped pieces of content such as, for example, one commercial or one chapter of a particular movie title. The segments may be referred to as “content segments.” The content segments may be put together into a “playlist” by switch unit 135. For example, a movie is broken into content segments to allow commercial breaks between each segment. Additionally, each content segment has a list of “random access points.” These points are locations within a given content segment where playback can begin.

In one embodiment, import preprocessor 148 generates separate “trick play” segments for each normal-play segment. Thus, the output of the import preprocessor 148 for each title is a metadata file and one or more files of block data. The title metadata may include the title name, the title encoding (e.g., UDP/IP or RTP/UDP/IP), and the list of video segments in the title, and each segment's associated metadata. The metadata for each segment may include timing information for the segment as a whole (e.g., bandwidth requirements and duration), the default block size for the segment, the timing information for each jumbogram within the segment, and the filename of file containing the video data (in blocks).

In addition, for each block in the video data, the metadata may include the time offset within the segment, the duration of the block, the optional block size, and the offset of the block within the video data file. Further, the segment metadata may include for each trick mode supported, the segment metadata corresponding to the trick mode segment. Additionally, the segment metadata may include a random-access table specifying all the random-access points within a segment, by jumbogram number and time offset. This table may also include cross-references with trick play segments to indicate where the corresponding points are located in the trick-play segments.

An MPEG-2 TS contains several tables that together enable a decoder to find all the pieces it needs to reconstruct a program. These tables are called Program Specific Information (PSI). The root PSI table is the transport stream Program Association Table (PAT). It is distinguished by being carried in a stream with a program identifier packet field (PID)=0. The PAT lists all of the programs in the Transport Stream, and for each program it supplies the PID of a second-level table referred to as a Program Map Table (PMT ). The PMT, in turn, lists the PID and the type of each stream that comprises the program (for example, video streams, audio streams, and data streams that together make up the entire program). Finally, there is a Conditional Access Table (CAT) that lists the PIDs of streams containing Entitlement Management Messages (EMMs) and Entitlement Control Messages (ECMs). The CAT is carried in a stream with PID=1, and is optional. In some embodiments, it may be necessary to generate the PAT, PMT, and CAT tables that describe the programs in a Multi-Program Transport Stream (MPTS), and these tables may need to be updated when the program stream is filtered or remultiplexed. The pre-processor inserts PAT, PMT, and CAT tables into each MPEG-2 Transport Stream (if they are not there already). At random access points, the transport stream PAT and the PMT may be inserted at the start of a jumbogram by the import preprocessor 148. These tables may also be inserted as required to meet frequency requirements.

In one embodiment, the import preprocessor 148 produces the trick play segments from the input stream by dropping and rearranging video I- and P-frames. Trick play segments are encoded with the same scheduling as their corresponding normal segments. Data from different MPEG streams (i.e., audio and video) may be reordered to provide a more efficient packing within media storage 140. The import preprocessor 148 attempts to preserve MPEG timing properties (so that if the original stream has no buffer underruns or overruns, neither does the result), but the switch unit 135 scheduling mechanism requires a dejittering mechanism to ensure MPEG compliance.

In one embodiment, prior to operation, the import preprocessor 148 may be configured with the set of desired trick play modes and target bandwidth by the CFE 146. If this target bandwidth is too small, the import preprocessor 148 may be configured to issue warnings and drop data in order to meet the schedule. In some embodiments, the B-frames are dropped first. Alternatively, the import preprocessor 148 may be configured to deliver all the data, but a stream which consistently requires higher bandwidth than the configured rate may produces poorer quality video.

In the illustrated embodiment, the media storage unit 140 includes a storage controller 240 coupled to a storage array 235. The storage array 235 provides non-transient non-volatile content storage for the stream system 130. In one implementation the storage array 235 may comprise a high-density disk array that is scalable in units of 10 Terabytes, for example, to provide very large content libraries without requiring content replication. In addition, the media storage 140 may be implemented as a high-performance redundant array of inexpensive disks (RAID) network disk storage system in which storage controller 240 may be configured to provide RAID controller functionality. Accordingly, the storage array 235 may include storage disks that store redundant information such as parity, for example. In addition, media storage 140 may include redundant power supplies (not shown) for reliability and availability. Further, media storage 240 may include dual 10 Gigabit Ethernet ports for redundant connectivity in systems that include a dual-redundant switch unit 135 configuration. It is noted that in alternative embodiments, the storage array 235 may be implemented using other types of non-volatile storage media including flash memory, RAM disk, optical media such as R/W CD-ROM or DVD, for example, among others.

In addition to providing RAID controller functionality, the storage controller 240 may be configured to execute software such as real time media store (RMS) to manage the transfer of content from disk storage to the switch unit 135. Thus, the storage controller 240 executing RMS is effectively an intermediary between the storage array 235 and the switch unit 125 providing content in the form and timing required by the switch. The RMS implements the block loading timing to off-load the switch unit 135 from this processing load. Subscriber interaction is separated out to keep the RMS (as a point of failure) as simple as possible, and to isolate the subscriber contact point from the possibly replicated distributed disk service provided by the media storage 140.

More particularly, in one embodiment, storage controller 240 manages the memory caching of content in the switch unit 135 in terms of creating cache segments, merging segments and deleting segments, in addition to adding and deleting blocks from these segments, and may be implemented by calls to the software executing on switch controller 205. A cache segment refers to a portion of a content segment that is stored in the memory cache 210.

In addition, storage controller 240 manages disk I/O capacity, including determining whether it is feasible to satisfy a subscriber request based on available disk I/O capacity. Further, storage controller 240 handles trick play commands to keep the disk I/O and switch unit 135 streams in synch with trick play-induced changes.

In various embodiments, a unit of video service corresponding to playing a specified (portion) of video segment over a specified stream at a specified time may be referred to as a SegStream. A stream group is a set of streams playing the same segment in content sufficiently close in time to share blocks of content and a single storage stream for loading content that is not present. The associated stream group model is the approach used to optimize the use of memory to minimize the amount of disk I/O required to deliver the offered load, within the constraints of the amount of memory available.

In addition, storage controller 240 may be configured to allocate disk bandwidth (and any associated network bandwidth) necessary to service a SegStream request from a CFE node, map each SegStream into a StreamGroup to control the caching of video blocks in the segment, and to deliver blocks to the switch unit 135 as required in time for video playout.

Furthermore, the media storage 140 is scalable and may be implemented as a rack-mount system in which multiple media storage 140 units may be interconnected to scale both the total storage and the bandwidth. For example, in one implementation, a single 19″ rack may hold ten storage arrays 235 with a total capacity of 100 Terabytes. In addition, the bandwidth capacity scales proportionally to the number of media storage units. Thus, a single rack with ten storage arrays 235 may provide aggregate bandwidth of over 25,000 streams. Assuming a central head-end with 100,000 streams, this corresponds to 25% of all streams.

As described above, the switch unit 135 is configured to be a centralized head end unit that combines the function of video content streaming, video switching, memory-based content caching, and network connectivity. Accordingly, in one embodiment, the switch unit 135 may comprise an integrated shared memory storage, streaming video switching and high-speed routing, as well as an optical transport system. To perform these functions, the switch unit 135 includes a very large shared memory cache 210 and switch controller 205. In addition, the switch unit 135 includes a Gigabit Ethernet I/O unit 215 and an optical transport unit 220.

It is noted that in one embodiment, the switch unit 135 may be implemented as a rack-mounted server system having one or more controller cards and a number of line cards. In such an embodiment, the controller cards may comprise the switch controller 205 and a redundant back up switch controller 205. The line cards may comprise the memory that makes up the memory cache 210. In addition, the system may include a number of optical transport cards, out of band cards and Ethernet transport card. Further, the rack system may include redundant power supplies.

In one embodiment, the memory cache 210 may be implemented using memory devices that belong to the dynamic random access memory (DRAM) family of devices. In one specific implementation the memory cache 210 may include storage capacity of one Terabyte or more.

In the illustrated embodiment, the switch controller 205 includes a crossbar switch, designated xbar 207, a processor 206, and a memory controller (MC) 208. In one embodiment, the processor 206 is configured to execute software such as a content streaming service (CSS), which may create new streams (referred to as CssStreams), create new segments of content (e.g., CssCacheSegments, add blocks of content to these segments, assign segments to be played by particular streams, and start and stop these streams. A stream specifies the delivery endpoint for the content and represents the reservation of bandwidth and streaming capacity of the switch unit 135. A cache segment is a contiguous, variable-sized aggregate for managing cached content.

In one implementation, the CSS exports the major objects of a CSS library, including CssStream and CssCacheSegment objects (and the associated managers). This library provides the software object layer for the CSS program. The program implementation is structured following the standard call-up/notify-down approach with a hardware management layer in this program interfacing directly to hardware and calling up into the CSS library layer. In addition, the CSS supports scheduling streams to avoid over-committing resources of the switch unit 135 using a scheduling library. The CSS also handles trick mode: the starting, stopping, pausing, rewinding, fast forwarding, etc. of streams. In addition, CSS may perform content segment changes. In one embodiment, a content segment change operation is performed whenever the playback of one content segment ends and the beginning of another content segment begins. Examples of instances where content segment changes occur are: a commercial inserted during the playback of a program, transitioning from normal speed play to trick play, etc. Content segment changes can occur automatically, as is the case with commercial insertion, or, may occur as a response to STB remote control input, as is the case with a FF request.

More particularly, to effect a content segment change that may change stream properties, the various components communicate the parameters of the affected stream. Specifically, the properties of the stream may be represented by a pair of state vectors. For example, the first state vector may comprise a number of state bits such as [PSP0, FitlerMask0, RemapTable0, PAT0, PMT0]. The second state vector may also comprise a number of state bits such as [PSP1, FitlerMask1, RemapTable1, PAT1, PMT1]. Two vectors are provided such that software can set up one vector while another is active, and then have hardware perform the actual switch at the appropriate time. Assuming that initially state vector 0 is active, the following procedure may be used to implement a segment change. The CFE 146 communicates stream properties to the CSS software executing in the processor 206. The MC 208 software programs the new properties into state vector 1. The processor 206 software Arms the stream by setting the appropriate state. At this point the processor 206 will begin looking for a segment boundary. When the boundary is found, the processor 206 software informs the CFE 146 that it is now ready. The CFE 146 instructs the switch unit 135 to switch segments. The switch unit 135 switches segments and switches the LSB bit (which is also referred to as the version bit) in the destination UDP port number for all subsequent packets. The processor 206 hardware detects the change in the UDP port number. It switches the active state vector to 1 and sets the Trigger. Once software has detected that the Trigger state has been set, the process is complete and the system is ready for the next segment change.

Each RMS uses the CSS to establish a stream to a subscriber, to create cache segments for handling the caching of blocks of content, and to bind cache segments to streams for specifying the content to be transmitted on a stream.

In one embodiment, MC 208 may be configured to schedule content for transmission. Specifically, the MC 208 schedules streaming data for egress with timing precision sufficient to send streaming content at the proper rate, without overloading egress ports. The scheduling policy implemented by the MC 208 and the software controlling it must use the output ports efficiently, and have limited burstiness and stream insertion delay. The policy must also be easy to support in hardware. Finally, the portion of the policy implemented in software must be computationally inexpensive as it is executed centrally on limited CPU resources.

In one implementation, the MC 208 uses data structures describing streams, blocks of content in memory, and transmission timing of each line of content in memory. For example, the MC 208 scheduling algorithm uses an event table or “stream scheduling table” to track when each virtual private stream should next transmit content. Each bucket is approximately 6.5 microseconds long, which corresponds to the time it takes to transmit 8 kilobytes of content on a 10 gigabit Ethernet port. The event table is 512K buckets (approx. 3.4 seconds) long. Software controlling MC 208 inserts active streams into the event table. Each time a stream appears in the bucket for the current time, the hardware transmits a line of content and places the stream in the bucket corresponding to the next time the stream should transmit data. Each line of content has timing metadata that allows the MC 208 to determine when the next line should be transmitted. For example, the metadata may include an offset (in scheduling table buckets), and three “tags” that are used to adjust the offset.

Efficiency is the ability of the scheduling algorithm to saturate the egress ports. The switch unit 135 hardware and software scheduling facilities provide high bandwidth utilization while guaranteeing that egress ports will not be overloaded. In one embodiment, when a stream starts, it is allocated transmission slots. To provide scheduling simplicity, the bandwidth allocation for a stream may be composed of up to four sub-allocations that are all powers of two multiples of a base rate. For example, if the base rate were 1 Mbps, a 15 Mbps stream would be allocated 1, 2, 4, and 8 Mbps sub-allocations. (The smallest base rate the scheduler can support is one slot per scheduling table cycle, or 19 Kbps.) Other rates are rounded up to the nearest such allocation. For example, a 14.3 Mbps stream would be allocated 15 Mbps. It is noted that in other embodiments, the MC 208 hardware may also support simpler allocation and scheduling policies, such as a simple base rate scheme. For example, in an environment with only fixed, known rates, simpler policies may be used.

The xbar 207 may provide high-bandwidth switching and routing for both the incoming formatted content that is stored within the memory cache 210, and the outgoing content streams read from the memory cache 210. More particularly, xbar 207 may be configured to route incoming formatted content from media storage 140 to the memory cache 210. For example, the xbar 207 may route the formatted content received from the media storage 140 via a plurality of network ports 231 to a plurality of network ports 232 that are coupled to the memory cache 210 using large block transfers (e.g., 1 Mbyte). It is noted that under direction of processor 206 executing the CSS, the xbar 207 may route the formatted content to any of the memory devices that comprise memory cache 210 by performing concurrent writes using any available network port, and it may access (read) multiple memory devices substantially simultaneously. Further, the xbar 207 may route for transmission, multiple content streams substantially simultaneously by performing concurrent reads from any of the memory devices using any available output port.

The stream system 130 may also be configured to switch between multicast and unicast streams as necessary in response to a user request. For example, a user may be viewing a particular movie title, for example, that is being broadcast in using multicast streams. However, if the user requests a trick play, or if the stream system 130 is configured to send targeted advertising to that user during the movie, the stream system 130 may switch to a unicast arrangement. Thus, switch unit 135 may be configured to create the unicast stream on the fly for that user. This capability may allow the switch to reduce the bandwidth requirements for content going to multiple subscribers while providing for unique targeted content to a subscriber when necessary.

The stream system 130 may include various failover mechanisms that may be monitored and administered on a system level by, for example, the CFE 146. In addition, some of the failover mechanisms may be handled within the failing subsystem. In either case the stream system 130 is designed with reliability, availability and serviceability in mind. All stream system 130 components, including switch unit 135, media storage 140, and the stream management system 145, are designed for carrier-class environments. Accordingly, they feature dual-redundant hot pluggable power supplies, hot-pluggable laser transceivers, and hot-pluggable fan-trays, which means all of these items may be swapped without affecting system operation. In addition, stream system 130 supports a load-sharing redundant network architecture that can tolerate the failure of any single component.

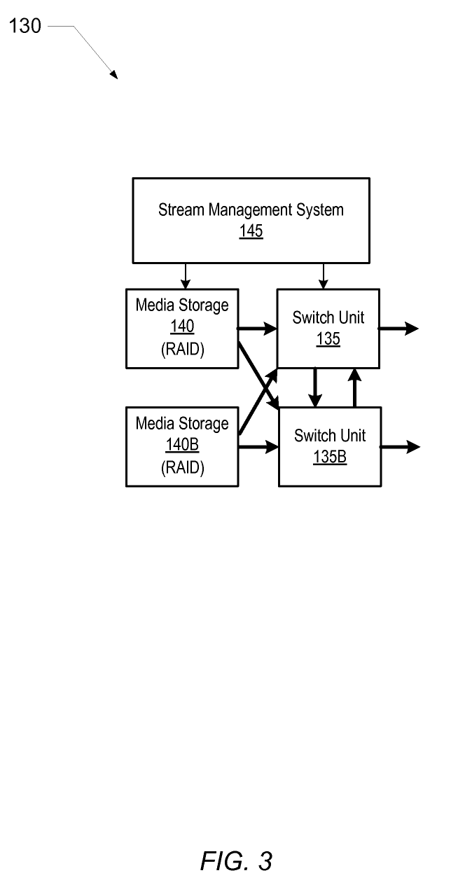

As shown in FIG. 3, an embodiment of a stream system 130 with redundant backup components is shown. In the illustrated embodiment, a redundant backup switch unit 135B is used. In the event of a failure of primary switch unit 135 (especially the switch controller 205), the external RMS and CFE may be configured to detect the failure and to switch over to using backup switch unit 135B, or in some embodiments, a backup switch controller 205 (not shown). For example, in a multi-supervisor configuration, i.e., one with multiple supervisor cards, the CSS should handle error detection and fail-over to the backup supervisor or to the backup switch unit 135B.

In various embodiments, the stream management system 145 is inherently redundant at the level of each CPU blade. The workload of a failed blade can be taken over by any other CPU blade in the server.

As shown, media storage 140 is paired with a mirror media storage 140B, thereby providing complete content redundancy. In one embodiment, all content loads (non-real-time and real-time) require a second copy to the mirror. The CFE 146 and import preprocessor 148 subsystems within the stream system 130 are responsible for directing the storage of the second copy dynamically.

In one embodiment failures and failover of the media storage 140 may be classified in two levels. The first level includes single disk failures, while the second level includes and media storage 140 system failures. As described above, single disk failure will utilize the appropriate RAID mechanism to parity check and rebuild content from the failed disk. However, multiple disk failures in the same RAID subsystem, or a board failure within the media storage 140, for example, will rely on the redundant media storage 140 to take the additional real-time access load initially. It is noted that dynamic replication will offload popular content from this potentially overloaded media storage 140 to minimize service disruption. The redundant media storage 140 eventually serves to rebuild the primary media storage 140 when the operator indicates the primary is repaired or replaced and ready.

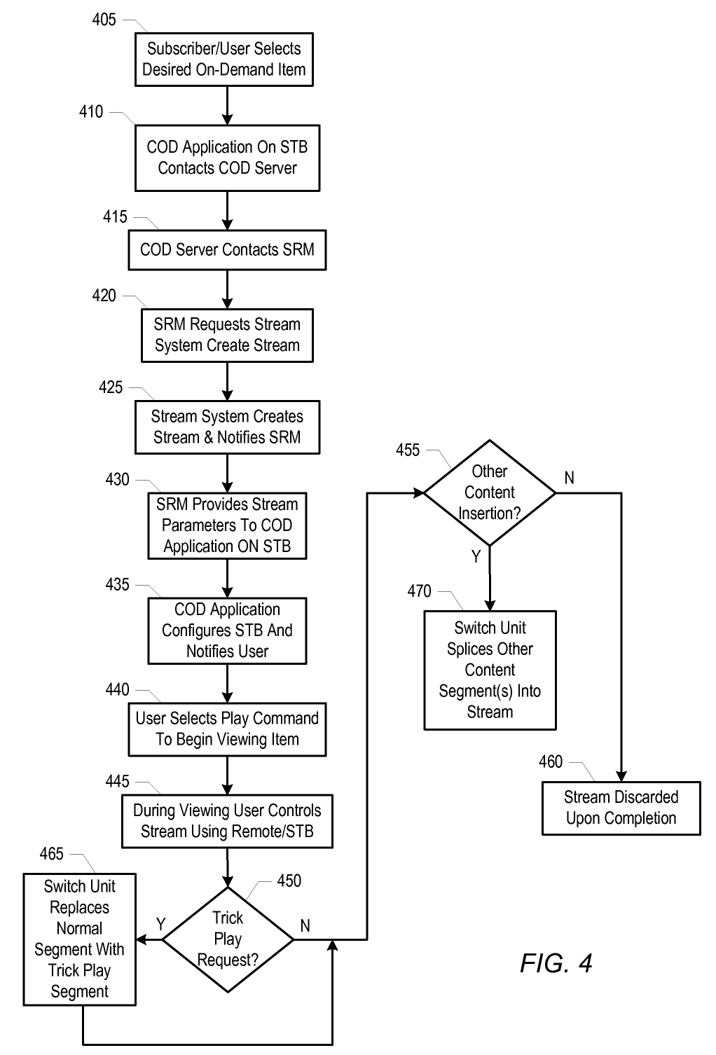

As described above, streams are used to deliver multimedia and IP content to set-top box client applications. However, before content can be delivered on a stream, the stream has to be created and provisioned, and information about the stream must be delivered to the set-top box so that it can control the stream. Although the details of stream creation are application and deployment specific, the following example shown in FIG. 4 illustrates the general principles involved. Accordingly, FIG. 4 is a flow diagram that describes stream creation and stream control aspects of the embodiments of FIG. 1 and FIG. 2.

Referring collectively to FIG. 1, FIG. 2 and FIG. 4, when a subscriber (user) decides to watch an on-demand selection such as a movie, for example, the user may select the movie title using a remote control or directly through the STB 120 (block 405). In some embodiments, the user may navigate the COD application user interface to choose the desired item. COD application software running on STB 120 contacts the COD application server 160 in the head end unit 105 to request the content item (block 410). In one implementation, the COD application software running on the STB 120 and the COD application server 160 may communicate via proprietary and application-specific protocols. The COD server 160 may then contact the SRM 165 to determine whether system resources are available to fulfill the request and to negotiate any business issues (block 415). In response, the SRM 165 requests the stream management system 145 create a stream to deliver the content to the subscriber. The SRM 165 may specify the content, and the stream parameters including the QAM device, the QAM frequency, and the MPEG program number to use for the stream (block 420). The stream system 130 creates the stream to deliver the content and when the stream has been created, notifies the SRM 165 that the stream was created successfully (block 425). For example, as described above, creating a stream may include import preprocessor 148 formatting the content and providing the content to media storage 140 to either be stored, or bypassed to the switch unit 135. In addition to formatting the data, import preprocessor 148 also creates any trick play segments that correspond to the normal segments. The formatted blocks of content data are sent to the switch unit 135, which creates the stream.

The SRM 165 notifies the COD application on STB 120 of the stream creation and provides the stream parameters (block 430). In addition the SRM 165 provides the IP address of the stream system 130 server that is serving the content (the IP address of the stream system 130 server is used by the COD application to address stream control messages. The COD application configures the STB 120 and provides an indication to the user that the item is ready for viewing (block 435). For example, the COD application may set the QAM tuner to the right frequency and configure the MPEG decoder and the conditional access descrambler within STB 120. To begin viewing the item, the user selects the PLAY command from a command menu, for example (block 440). The COD application sends the PLAY command to the stream system 130 server, using the IP address received from the SRM. The stream begins and during viewing, the user may control the stream using the remote/STB 120 and selecting commands from a command menu and the CD application sending the commands to the stream server using the IP address (block 445). If no trick plays are selected (block 450), operation continues in block 455. If there is no other content such as advertising, for example, to be inserted into the stream operation continues until completion of the stream. When the content item completes, the stream may be discarded, and flushed from memory 210 of switch unit 135 (block 460).

Referring back to block 450, if the user selects a trick play such as pause, fast forward, slow play, or rewind the trick play command request is communicated to stream system 130 as described above. In response, processor 206 within switch unit 135 may replace the segment corresponding to the trick play request with the associated trick play segment (block 465). Most stream control commands refer to Normal Play Time (NPT). NPT is an index value (measured in integer milliseconds) into the stream. The start of the stream is at position NPT=0. The direction and speed of play is determined by the scale parameter, which is a signed rational number. Accordingly, for some commands the stream scale parameter for the content stream may be increased or decreased. When trick play has concluded, switch unit resumes sending the stream segments normally, as described above. It is noted that the user may request a channel change. In this case the stream may be stopped in response to this command.

Referring back to block 455, as mentioned above content segment changes may occur as a result of requests made by a user, or automatically such as in the case of advertisement insertion. For example, advertisements, and other content may be inserted into a stream between content segments. Processor 206 of switch unit 135 may determine where to insert the additional content, and then insert it into the stream seamlessly. For example, to preserve seamless segment switches in one embodiment, the additional content may be encoded at the same rate as the stream content. Operation proceeds as describe above in the description of block 460.

To accommodate the above system functionality, the stream management system 145 may be configured to operate in a distributed environment in which a number of stream management systems may be interconnected and operated concurrently. For example, in one embodiment, any number of stream management systems 145 may be networked together to provide hundreds of thousands of concurrent media streams to subscribers. In such an embodiment, the system software may operate to form a distributed control plane and a distributed data plane. In one embodiment, the stream management system 145 distributes active subscriber sessions across its multiple blades to provide scalable performance with high availability and good subscriber response.

It is noted that although the system shown in FIG. 1 is referred to as a cable television system, it is noted that the stream system 130 may used in any media distribution system including a video distribution system, and/or an audio distribution system that distributes video and/or audio to subscribers via twisted pairs. In addition certain Internet Service Providers (ISP) having enough bandwidth may use such a streaming system to provide media distribution to their subscribers.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A switch comprising:
a volatile memory configured to store one or more formatted media content streams;
a plurality of network ports providing a digital transport for conveying the one or more concurrent media streams for use by the subscriber; and
a switch controller including a crossbar switch coupled between the plurality of network ports and the volatile memory, wherein the switch controller is configured to create one or more concurrent media streams from one of the one or more formatted media content streams by concurrently performing read operations to a plurality of portions of the volatile memory, and to concurrently route the one or more concurrent media streams via any of the plurality of network ports.

2. The switch as recited in claim 1, wherein the switch controller includes a processor configured to replace one or more content segments of a given media content stream with one or more trick play segments in response to a trick play request by the subscriber.

3. The switch as recited in claim 1, wherein the switch controller includes a processor configured to replace one or more content segments of a given media content stream with one or more advertisement segments.

4. The switch as recited in claim 2, wherein the processor is further configured to determine where in the given media content stream to replace the one or more content segments based upon metadata included in the stream, wherein the metadata includes entry points in the given media content stream.

5. The switch as recited in claim 1, wherein the switch controller includes a memory controller configured to schedule for transmission the one or more concurrent media streams.

6. The switch as recited in claim 1, wherein the switch controller is configured to switch from a multicast stream to unicast stream in response to a user request for specific content.

7. The switch as recited in claim 1, wherein the switch controller is configured to switch from a multicast stream to unicast stream in response to a command to insert a user targeted advertisement into a content stream.

8. The switch as recited in claim 1, wherein the volatile memory comprises a plurality of memory devices in the dynamic random access memory (DRAM) family of memory devices.

9. The switch as recited in claim 8, wherein switch controller is further configured to perform a plurality of read operations concurrently from any portion of the plurality of memory devices of the volatile memory via the crossbar switch, and to perform a plurality of write operations concurrently to another portion of the plurality of memory devices of the volatile memory via the crossbar switch, wherein the switch controller is further configured to perform the plurality of read operations and the plurality of write operations concurrently.

10. The switch as recited in claim 1, wherein the switch controller is configured to receive, from a non-volatile storage, formatted media content corresponding to the one or more formatted media content streams as needed via the plurality of network ports.

11. The switch as recited in claim 1, wherein the crossbar switch is further configured to transfer the media content between the volatile memory and the plurality of network ports at a data rate capacity of the plurality of network ports.

12. A media streaming system comprising:
a stream manager including a preprocessor configured to format an incoming media content stream into blocks;
a media storage coupled to the stream manager and configured to store the formatted blocks of the media content stream; and
a switch unit including:
a volatile memory configured to store one or more formatted media content streams;
a plurality of network ports;
a switch controller including a crossbar switch coupled between the plurality of network ports and the volatile memory, wherein the switch controller is configured to create one or more media streams from one of the one or more formatted media content streams by concurrently performing read operations to a plurality of portions of the volatile memory, and to concurrently route the one or more concurrent media streams via any of the plurality of network ports.

13. The system as recited in claim 12, wherein the preprocessor is configured to create trick play segments that correspond to normal content segments and to include information associated with the trick play segments in the formatted media content stream blocks.

14. The system as recited in claim 12, wherein switch controller is further configured to perform a plurality of read operations concurrently from any portion of the volatile memory via the crossbar switch, and to perform a plurality of write operations concurrently to another portion of the volatile memory via the crossbar switch, wherein the switch controller is further configured to perform the plurality of read operations and the plurality of write operations concurrently.

15. The system as recited in claim 12, wherein the switch unit includes a digital transport for conveying the one or more concurrent media streams for use by the subscriber.

16. The system as recited in claim 13, wherein the switch controller is configured to replace one or more normal content segments of a given media content stream with one or more trick play segments in response to a trick play request by the subscriber.

17. The system as recited in claim 16, wherein the switch controller is further configured to determine where in the given media content stream to replace the one or more normal content segments based upon metadata included in the stream, wherein the metadata includes entry points in the given media content stream.

18. The system as recited in claim 12, wherein the switch controller is configured to replace one or more content segments of a given media content stream with one or more advertisement segments.

19. The system as recited in claim 12, wherein the media storage includes a storage controller and one or more hard disk arrays controlled by the storage controller.

20. The system as recited in claim 12, wherein the switch controller is configured to schedule the one or more concurrent media content streams for transmission.

21. The system as recited in claim 12, wherein the switch controller is configured to switch from a multicast stream to unicast stream in response to a command to insert a user targeted advertisement into a content stream.

22. The system as recited in claim 12, wherein the crossbar switch is configured to transfer the formatted blocks of the media content stream between the volatile memory and the plurality of network ports at a data rate capacity of the plurality of network ports.

23. A video distribution system comprising:
a head end unit;
a distribution hub coupled to the head end unit, wherein the head end unit includes:
a stream system comprising:
a stream manager including a preprocessor configured to format an incoming media content stream into blocks;
a media storage coupled to the stream manager and configured to store the formatted blocks of the media content stream;
a switch unit including:
a volatile memory configured to store one or more formatted media content streams;
a plurality of network ports;
a switch controller including a crossbar switch coupled between the plurality of network ports and the volatile memory, wherein the switch controller is configured to create one or more media streams from one of the one or more formatted media content streams by concurrently performing read operations to a plurality of portions of the volatile memory, and to concurrently route the one or more concurrent media streams via any of the plurality of network ports.
